(19) United States
(12) Patent Application Publication
(10) Pub. No.: US 2024/0280121 A1
(43) Pub. Date: Aug. 22, 2024

(54) FLOW RECTIFIER

(71) Applicant: Endress+Hauser Flowtec AG, Reinach (CH)

(72) Inventors: Andreas Strub, Weil am Rhein (DE); Marc Hollmach, Basel (CH); Rainer Höcker, Waldshut (DE); Vivek Kumar, Allschwil (CH); Dominique Wiederkehr, Hagenthal-le-bas (FR); Sascha Kamber, Tenniken (CH); Anton Rieger, Herrischried (DE); Matteo Grasso, Zürich (CH); Matthias Schmid, Küttigen (CH)

(21) Appl. No.: 18/571,344

(22) PCT Filed: May 18, 2022
(86) PCT No.: PCT/EP2022/063478

§ 371 Date: Dec. 18, 2023

(30) Foreign Application Priority Data
Jun. 18, 2021 (DE) 10 2021 115 885.0

(51) Int. Cl. F15D 1/02; G01F 1/32; G01F 1/66; G01F 1/684

(52) U.S. Cl. CPC F15D 1/025; G01F 1/3209; G01F 1/662; G01F 1/6842

(57) ABSTRACT

The flow conditioner comprises a diffusor with a guide system arranged within its lumen, a flow rectifier with a disc shaped flow obstruction arranged within its lumen, wherein the flow obstruction has a plurality of flow openings, as well as a confusor, wherein diffusor, flow rectifier and confusor are connected fluidically in series to form a flow path extending from a flow opening of the diffusor to a flow opening of the confusor and involving the lumina of diffusor, flow rectifier and confusor. The guide system of the diffusor includes a sleeve shaped deflection means as well as a plurality of mutually separated connecting elements connected both with the deflection means as well as with the wall of the diffusor. The guide system is so formed and so positioned that the deflection means is spaced from the wall of the diffusor and arranged coaxially with the lumen of the diffusor.

The invention relates to a flow conditioner as well as to a measuring system formed therewith for measuring one or more measured variables of a flowing, measured substance.

For measuring fluid, measured substances, for example, a gas or a liquid, flowing in pipelines with predetermined flow direction using flowmeters integrated into the course of the pipeline, for example, an ultrasonic flowmeter, a magnetically inductive flowmeter, a vortex flowmeter or a thermal, mass flowmeter, it is, particularly because of the particular principle of measurement applied, regularly required appropriately to condition the measured substance in an ideally as short as possible inlet path lying in the feed line of the flowmeter, in such a manner that possible measuring corrupting, upstream disturbances, for example, in the form of a swirl or a double-swirl, are eliminated in sufficient measure from the (measured substance)flow, and that a (measured substance)flow having a best possible flow profile suitable for measuring is formed. Such a flow conditioner, especially one serving for a reducing a degree of turbulence, or an intensity of turbulence (turbulence intensity), of the (measured substance-)flow, and a measuring system formed therewith having a flowmeter in the form of an ultrasonic flowmeter arranged downstream from the flow conditioner, is described in, among others, U.S. Pat. No. 6,647,806. The flow conditioner disclosed there has a conical-diffusor with a lumen surrounded by an essentially funnel shaped wall of metal, extending from a circularly shaped, first flow opening located in a first diffusor-end, for example, a first diffusor-end framed in a connecting flange, to a second flow opening located in a second diffusor-end, and rotationally symmetric with respect to an (imaginary) longitudinal axis of the diffusor, namely an essentially frustoconically shaped lumen. Moreover, the flow conditioner comprises a flow rectifier with a lumen, which is essentially circularly cylindrical with respect to an (imaginary) longitudinal axis of the flow rectifier, surrounded by a wall of metal, and which extends from a first flow opening located in a first flow rectifier-end to a second flow opening located in a second flow rectifier-end, as well as a (conical-)confusor with a lumen surrounded by an essentially funnel shaped wall of metal, extending from a first flow opening located in a first confusor-end to a circularly shaped second flow opening located in a second confusor-end, for example, a second confusor-end framed in a connecting flange, and rotationally symmetric with respect to an (imaginary) longitudinal axis of the confusor, namely an essentially frustoconically shaped lumen. The flow rectifier includes, additionally, one or more disk shaped flow obstructions mutually spaced in the flow direction, arranged within its lumen, and having, in each case, a plurality of circularly shaped flow openings. Such flow obstructions, at times also referred to as perforated plates, are known from, among others, also U.S. Pat. No. 5,529,093, US-A 2018/0112690 and US-A 2016/0061372. Diffusor, flow rectifier and confusor of the above described flow conditioner are additionally connected fluidically in series to form a flow path extending from the first flow opening of the diffusor to the second flow opening of the confusor, namely a flow path involving the lumina of diffusor, flow rectifier and confusor, in such a manner that the second diffusor-end is connected with the first flow rectifier-end and the second flow rectifier end is connected with the first confusor-end and that an imaginary longitudinal-, or flow, axis of the flow conditioner imaginarily connecting an (area-)center of gravity of the first flow opening of the diffusor and an (area-)center of gravity of the second flow opening of the confusor is in parallel with a principal axis of inertia (longitudinal axis) of the lumen of the diffusor and a principal axis of inertia (longitudinal axis) of the lumen of the confusor, as well as also with an (imaginary) longitudinal-, or flow, axis of the lumen of the flow rectifier imaginarily connecting an (area-)center of gravity of the first flow opening of the flow rectifier and an (area-)center of gravity of the second flow opening of the flow rectifier.

Investigations of such measuring systems have, however, shown that the measurement accuracies achieved therewith can, at times, be subject to considerable fluctuations, especially in the case of high Reynolds number of greater than 5000 and/or over a widen range of variable Reynolds number, in spite of the low degree of turbulence achieved by means of the flow conditioner connected in front of the flowmeter; this regularly also in such measure that, for a nevertheless sufficiently stable measuring, an (actually not desired) increasing of the inlet path to greater than 10-times a nominal diameter of the flow conditioner, or of the measuring system formed therewith, is required.

Taking this into consideration, an object of the invention is so to improve the above described flow conditioner that therewith in the case of as short as possible installed length, especially of less than 5-times a nominal diameter of the flow conditioner, also in the case of Reynolds numbers fluctuating over a wide range of greater than 1000 and/or in the case of high Reynolds number of above 5000, a measuring performed with a following flowmeter delivers for a flowing, measured substance stable, equally as well, precise measurement results; this, especially, also with an as little as possible pressure loss, especially of less than 3-times a pressure loss in the measured substance flowing with equal flow velocity through a smooth, straight tube of equal nominal diameter (caliber) and equal installed length.

For achieving the object, the invention resides in a flow conditioner for a fluid flowing in a pipeline, especially a pipeline having a nominal diameter of greater than 15 mm, especially with a Reynolds-number of greater than 1000, especially for producing a fluid flow with uniform or isotropic turbulence, comprising:
a diffusor, especially a diffusor formed as a cone-diffusor or ring diffusor, having a lumen surrounded by a funnel shaped, especially at least sectionally frustoconically shaped, wall, especially a metal wall, extending from an, especially circularly shaped, first flow opening located in a first diffusor-end, especially a first diffusor-end framed by a connecting flange, to a second flow opening located in a second diffusor-end, especially a lumen rotationally symmetric with respect to an at least fourfold (imaginary) rotation axis of the diffusor and/or at least sectionally frustoconically shaped, and having a guide system arranged within the lumen, especially a guide system serving for preventing boundary layer separation and for removing swirl from the flowing fluid;
a flow rectifier, especially a flow rectifier rotationally symmetric with respect to an (imaginary) longitudinal axis, having a lumen surrounded by a wall, especially a metal wall, and extending from a first flow opening located in a first flow rectifier-end to a second flow opening located in a second flow rectifier end, especially a lumen rotationally symmetric with respect to an at least fourfold (imaginary) rotation axis of the flow rectifier and/or a circularly cylindrical lumen, and having at least one disc shaped (first) flow obstruction, especially a perforated plate, a turbulence mesh or a sieve, arranged within the lumen and having a plurality of flow openings, especially circularly shaped and/or polygonal flow openings; as well as
a confusor having a lumen surrounded by a funnel shaped, especially at least sectionally bell shaped and/or at least sectionally trumpet shaped, wall, especially a metal wall, and extending from a first flow opening located in a first confusor-end to an, especially circularly shaped, second flow opening located in a second confusor-end, especially a second confusor-end framed by a connecting flange, especially an at least sectionally bell shaped and/or at least sectionally trumpet shaped lumen and/or a lumen rotationally symmetric with respect to an at least fourfold (imaginary) rotation axis of the confusor;
wherein diffusor, flow rectifier and confusor are connected fluidically in series to form a flow path extending from the first flow opening of the diffusor to the second flow opening of the confusor, namely a flow path involving the lumina of diffusor, flow rectifier and confusor, especially in that the second diffusor-end is connected with the first flow rectifier-end and the second flow rectifier end is connected with the first confusor-end and/or in such a manner that an imaginary longitudinal-, or flow, axis of the flow conditioner imaginarily connecting an (area-)center of gravity of the first flow opening of the diffusor and an (area-)center of gravity of the second flow opening of the confusor coincides with a principal axis of inertia (longitudinal axis) of the lumen of the diffusor and/or a principal axis of inertia (longitudinal axis) of the lumen of the confusor and/or an (imaginary) longitudinal-, or flow, axis of the lumen of the flow rectifier imaginarily connecting an (area-)center of gravity of the first flow opening of the flow rectifier and an (area-)center of gravity of the second flow opening of the flow rectifier;
wherein the guide system has at least one sleeve shaped, especially at least sectionally hollow cylinder shaped and/or at least sectionally funnel shaped and/or with respect to an at least fourfold (imaginary) rotation axis (longitudinal axis) rotationally symmetric, first deflection means, especially a metal first deflection means, as well as a plurality of mutually separated connecting elements each connected both with the first deflection means as well as also with the wall of the diffusor, especially rod shaped and/or plate shaped and/or equally-constructed connecting elements and/or connecting elements arranged star shaped along a lateral surface of the first deflection means facing the wall of the diffusor and/or each embodied as a guide means and/or arranged equidistantly along a peripheral line of the lateral surface of the first deflection means, especially connecting elements of metal; and
wherein the guide system is so formed and so positioned that the first deflection means is arranged spaced from the wall of the diffusor and coaxially with the lumen of the diffusor, especially in such a manner that a principal axis of inertia of the first deflection means coincides with a principal axis of inertia of the lumen of the diffusor.

Moreover, the invention resides, furthermore, in a measuring system for measuring at least one measured variable of a fluid, especially a gas, a liquid or a dispersion, flowing, especially, in a pipeline, with a flow direction, wherein the measuring system comprises a flow conditioner as above described.

In a first embodiment of the invention, it is, additionally, provided that the guide system is so formed and so positioned that one or more subsections of the flow path of the flow conditioner extend through the first deflection means.

In a second embodiment of the invention, it is, additionally, provided that the guide system is so formed and so positioned that one or more subsections of the flow path of the flow conditioner extend between the first deflection means and the wall of the diffusor.

In a third embodiment of the invention, it is, additionally, provided that the guide system is so formed and so positioned that, in each case, a subsection of the flow path of the flow conditioner extends between two neighboring connecting elements connected, in each case, with the first deflection means and the wall of the diffusor.

In a fourth embodiment of the invention, it is, additionally, provided that the guide system and the wall of the diffusor are so embodied that a (first) critical flare angle φ1 of the diffusor, measured as a greatest (section-)angle between a lateral surface element of the deflection means and an opposite, or nearest, surface element of an inner surface of the wall of the diffusor facing the lumen of the diffusor amounts to less than 8°, especially no greater than 6°.

In a fifth embodiment of the invention, it is, additionally, provided that a principal axis of inertia of the first deflection means, corresponding especially to an at least fourfold rotation axis of the deflection means, coincides with a principal axis of inertia of the lumen of the diffusor, corresponding especially to an at least fourfold rotation axis of the lumen of the diffusor.

In a sixth embodiment of the invention, it is, additionally, provided that the guide system is rotationally symmetric with respect to an at least threefold (imaginary) rotation axis (longitudinal axis), especially a rotation axis coinciding with a principal axis of inertia of the lumen of the diffusor.

In a seventh embodiment of the invention, it is, additionally, provided that at least three, especially greater than four, connecting elements are formed each as an, especially, flat and/or symmetrically profiled, guide means.

In an eighth embodiment of the invention, it is, additionally, provided that a vane ring is formed by means of the connecting elements, especially a vane ring serving for removing swirl from a fluid flowing through the diffusor.

In a ninth embodiment of the invention, it is, additionally, provided that the guide system has a sleeve shaped, especially at least sectionally hollow cylinder shaped and/or at least sectionally funnel shaped and/or with respect to an at least fourfold (imaginary) rotation axis (longitudinal axis) rotationally symmetric, second deflection means, especially a metal second deflection means, as well as a plurality of mutually separated connecting elements, especially metal connecting elements, in each case, connected both with the second deflection means as well as also with the first deflection means, especially rod shaped and/or plate shaped and/or equally-constructed connecting elements and/or arranged star shaped along a lateral surface of the second deflection means facing the first deflection means and/or, in each case, embodied as a guide means and/or arranged equidistantly along a peripheral line of the lateral surface of the second deflection means; wherein the guide system is so formed and so positioned that the second deflection means is arranged spaced from both the wall of the diffusor as well as also the first deflection means and coaxially with the lumen of the diffusor, especially in such a manner that a principal axis of inertia of the second deflection means coincides with a principal axis of inertia of the lumen of the diffusor and/or with a principal axis of inertia of the first deflection means. Developing this embodiment of the invention further, it is, additionally, provided that the guide system is so formed and so positioned that one or more subsections of the flow path of the flow conditioner extend through the second deflection means and/or that one or more subsections of the flow path of the flow conditioner extend between the second deflection means and the first deflection means and/or that, in each case, a subsection of the flow path of the flow conditioner extends between two neighboring connecting elements connected, in each case, with the first deflection means and the second deflection means. Alternatively or supplementally, the guide system of the diffusor is, furthermore, so embodied that a (second) critical flare angle φ2 of the diffusor, measured as a greatest (section-)angle between a lateral surface element of the second deflection means and an opposite, or nearest, surface element of an inner surface of the first deflection means facing the second deflection means amounts to less than 8°, especially no greater than 6°.

In a tenth embodiment of the invention, it is, additionally, provided that a first flow cross section of the confusor provided by the first flow opening of the confusor is greater than a second flow cross section of the confusor provided by the second flow opening of the confusor, especially in such a manner that the first flow cross section of the confusor amounts to greater than 1.4-times the second flow cross section of the confusor, especially amounts to not less than 2-times the second flow cross section of the confusor and/or no more than 25 times the second flow cross section of the confusor. Developing this embodiment of the invention further, it is, additionally, provided that the first flow cross section of the confusor is the same size as the second flow cross section of the diffusor and/or that the first flow cross section of the diffusor is the same size as the second flow cross section of the confusor.

In an eleventh embodiment of the invention, it is, additionally, provided that a principal axis of inertia (longitudinal axis) of the lumen of the diffusor coincides with an imaginary longitudinal-, or flow, axis of the flow conditioner imaginarily connecting an (area-)center of gravity of the first flow opening of the diffusor and an (area-)center of gravity of the second flow opening of the confusor.

In a twelfth embodiment of the invention, it is, additionally, provided that an (imaginary) longitudinal-, or flow, axis of the lumen of the diffusor imaginarily connecting an (area-)center of gravity of the first flow opening of the diffusor and an (area-)center of gravity of the second flow opening of the diffusor coincides with an imaginary longitudinal-, or flow, axis of the flow conditioner imaginarily connecting an (area-)center of gravity of the first flow opening of the diffusor and an (area-)center of gravity of the second flow opening of the confusor.

In a thirteenth embodiment of the invention, it is, additionally, provided that a principal axis of inertia (longitudinal axis) of the lumen of the confusor coincides with an imaginary longitudinal-, or flow, axis of the flow conditioner imaginarily connecting an (area-)center of gravity of the first flow opening of the diffusor and an (area-)center of gravity of the second flow opening of the confusor.

In a fourteenth embodiment of the invention, it is, additionally, provided that an (imaginary) longitudinal-, or flow, axis of the lumen of the confusor imaginarily connecting an (area-)center of gravity of the first flow opening of the confusor and an (area-)center of gravity of the second flow opening of the confusor coincides with an imaginary longitudinal-, or flow, axis of the flow conditioner imaginarily connecting an (area-)center of gravity of the first flow opening of the diffusor and an (area-)center of gravity of the second flow opening of the confusor.

In a fifteenth embodiment of the invention, it is, additionally, provided that an (imaginary) longitudinal-, or flow, axis of the lumen of the flow rectifier imaginarily connecting an (area-)center of gravity of the first flow opening of the flow rectifier and an (area-)center of gravity of the second flow opening of the flow rectifier coincides with an imaginary longitudinal-, or flow, axis of the flow conditioner imaginarily connecting an (area-)center of gravity of the first flow opening of the diffusor and an (area-)center of gravity of the second flow opening of the confusor.

In a sixteenth embodiment of the invention, it is, additionally, provided that a first flow cross section of the diffusor provided by the first flow opening of the diffusor is less than a second flow cross section of the diffusor provided by the second flow opening of the diffusor, especially in such a manner that the second flow cross section of the diffusor amounts to greater than 1.4-times the first flow cross section of the diffusor. Developing this embodiment of the invention further, it is, additionally, provided that the second flow cross section of the diffusor amounts to greater than 1.4-times the first flow cross section of the diffusor, especially amounts to not less than 2 times the first flow cross section of the diffusor and/or no more than 25 times the first flow cross section of the diffusor; and/or that a flow cross section of a largest flow opening of the first flow obstruction amounts to not less than 0.1-times the first flow cross section of the diffusor and/or no more than 0.3 times the first flow cross section of the diffusor.

In a seventeenth embodiment of the invention, it is, additionally, provided that a first flow cross section of the diffusor provided by the first flow opening of the diffusor is less than second flow cross section of the diffusor provided by the second flow opening of the diffusor, especially in such a manner that the second flow cross section of the diffusor amounts to greater than 1.4-times the first flow cross section of the diffusor, and an installed length of the flow conditioner, measured as a (smallest) separation between the first diffusor-end and the second confusor end, amounts to no more than 15 times, especially less than 12 times, a square root of the first flow cross section of the diffusor and/or no more than 12 times, especially less than 10 times, a hydraulic diameter of the first flow opening of the diffusor and/or a nominal diameter of the flow rectifier especially amounts to no more than 5 times the hydraulic diameter of the first flow opening of the diffusor, or the nominal diameter of the flow rectifier. Developing this embodiment of the invention further, it is, additionally, provided that a length of the diffusor amounts to not less than 0.2 times and/or no more than 0.4 times the installed length of the flow conditioner and/or that a length of the diffusor amounts to no more than 7 times the square root of the first flow cross section of the diffusor and/or no more than 6 times the hydraulic diameter of the first flow opening of the diffusor and/or the nominal diameter of the flow rectifier.

In an eighteenth embodiment of the invention, it is, additionally, provided that a first flow cross section of the diffusor provided by the first flow opening of the diffusor is less than a second flow cross section of the diffusor provided by the second flow opening of the diffusor, especially in such a manner that the second flow cross section of the diffusor amounts to greater than 1.4-times the first flow cross section of the diffusor, and a first flow cross section of the flow rectifier provided by the first flow opening of the flow rectifier is the same size as the second flow cross section of the diffusor. Developing this embodiment of the invention further, it is, additionally, provided that a second flow cross section of the flow rectifier provided by the second flow opening of the flow rectifier is the same size as the first flow cross section of the flow rectifier and/or the first flow cross section of the confusor, and/or that a first reduced flow cross section of the flow rectifier provided, in total, by the flow openings of the first flow obstruction of the flow rectifier is not less than 0.3-times the first flow cross section of the flow rectifier.

In a nineteenth embodiment of the invention, it is, additionally, provided that a nominal diameter of the flow conditioner amounts to greater than 15 mm, especially not less than 50 mm.

In a twentieth embodiment of the invention, it is, additionally, provided that a hydraulic diameter of the first flow opening of the diffusor amounts to greater than 15 mm, especially not less than 50 mm.

In a twenty-first embodiment of the invention, it is, additionally, provided that the at least one flow obstruction has flow openings with flow cross sections differing from one another, especially in such a manner that a flow cross section of a largest flow opening of the first flow obstruction amounts to not less than 1.1-times and/or no more than 1.5 times a smallest flow opening of the first flow obstruction.

In a twenty-second embodiment of the invention, it is, additionally, provided that the flow rectifier has at least a second flow obstruction, which is disc shaped and has a plurality of flow openings, especially a second flow obstruction having a construction different from the first flow obstruction. Developing this embodiment of the invention further, it is, additionally, provided that a first reduced flow cross section of the flow rectifier provided, in total, by the flow openings of the first flow obstruction of the flow rectifier is not greater than a second reduced flow cross section of the flow rectifier provided, in total, by the flow openings of the second flow obstruction of the flow rectifier and/or that a flow cross section (hydraulic diameter) of a largest flow opening of the first flow obstruction is not less than a flow cross section of a largest flow opening of the second flow obstruction and/or that the first and second flow obstructions of the flow rectifier are spaced from one another in the direction of an (imaginary) longitudinal axis of the flow rectifier, especially by not less than 5-times a square root of a flow cross section of a largest flow opening of the first flow obstruction and/or by not less than 5-times a hydraulic diameter of a largest flow opening of the first flow obstruction.

In a twenty-third embodiment of the invention, it is, additionally, provided that the flow rectifier has at least a second flow obstruction, which is disc shaped and has a plurality of flow openings, especially a second flow obstruction having a construction different from the first flow obstruction as well as at least a third flow obstruction, which is disc shaped and has a plurality of flow openings, especially a third flow obstruction having a construction different from the first flow obstruction and/or the second flow obstruction.

In a twenty-fourth embodiment of the invention, it is, additionally, provided that the flow conditioner is adapted to be inserted into the course of a pipeline, especially releasably and/or by means of flange connections.

In a twenty-fifth embodiment of the invention, it is, additionally, provided that the wall of the diffusor has at least one wall-opening, especially for connecting a condensate outlet, a gas separator, a pressure measuring device or a temperature measuring device.

In a twenty-sixth embodiment of the invention, it is, additionally, provided that the wall of the confusor has at least one wall-opening, especially for connecting a condensate outlet, a gas separator, a pressure measuring device or a temperature measuring device.

In a twenty-seventh embodiment of the invention, it is, additionally, provided that the wall of the confusor has at least two, especially diametrally opposite, wall-openings, especially for connecting both a pressure measuring device as well as also a temperature measuring device to the flow conditioner or for connecting an ultrasonic measuring device to the flow conditioner.

In a twenty-eighth embodiment of the invention, it is, additionally, provided that the flow conditioner is at least partially produced by an additive production method, especially a free space and/or powder bed method.

In a twenty-ninth embodiment of the invention, it is, additionally, provided that at least the guide system of the diffusor is an, especially additively produced, monolithic, formed part.

In a thirtieth embodiment of the invention, it is, additionally, provided that the deflection means and the connecting elements of the guide system are components of one and the same, especially additively produced, monolithic, formed part, especially, in such a manner that both the deflection means, the connecting elements as well as the wall of the diffusor are components of one and the same monolithic, formed part.

In a first further development of the measuring system of the invention, such comprises, additionally, a flowmeter, especially a vortex-flowmeter or thermal (mass flow)meter, arranged downstream from the flow conditioner, especially a flowmeter connected to the confusor; for example, in such a manner that the flow conditioner and the flowmeter are connected fluidically in series to form a flow path extending from the first flow opening of the diffusor to an outlet opening of the flowmeter located in a flowmeter-outlet end remote from the second confusor-end, namely a flow path involving both the lumina of diffusor, flow rectifier and confusor as well as also a lumen of the flowmeter extending from an inlet opening of the flowmeter located in a flowmeter-inlet end to its outlet opening, especially in that the flowmeter-inlet end is connected with the second confusor-end.

In a second further development of the measuring system of the invention, such comprises, additionally, a temperature-measuring device arranged at the wall of the confusor of the flow conditioner, especially having at least one temperature sensor positioned within the lumen of the confusor and/or electrically connected with a flowmeter arranged downstream from the flow conditioner.

In a third further development of the measuring system of the invention, such comprises, additionally, a pressure-measuring device arranged at the wall of the confusor of the flow conditioner, especially having a pressure sensor contacting its lumen via an opening in the wall of the confusor and/or electrically connected with a flowmeter arranged downstream from the flow conditioner.

In a fourth further development of the measuring system of the invention, such comprises, additionally, an (ultra-)sonic measuring device arranged at the wall of the confusor of the flow conditioner, especially having a microphone contacting the wall of the confusor on a lumen far, outside of the wall and/or two mutually oppositely lying ultrasound-transceivers, each contacting the wall of the confusor on a lumen far, outside of the wall and/or electrically connected with a flowmeter arranged downstream from the flow conditioner.

In a fifth further development of the measuring system of the invention, such comprises, additionally, in the wall of the confusor at least one wall-opening, especially one located in the direction of the force of gravity at a deepest or highest point of the confusor and/or equipped with a connection nozzle and/or closed with a plug, especially a wall-opening serving for connecting a condensate outlet, a gas separator, a pressure measuring device or a temperature measuring device.

A basic idea of the invention is by means of a guide system positioned in the inlet region of the flow conditioner of the invention reliably to prevent otherwise, at times, brought about, especially in the case of high Reynolds number of greater than 1000, equally as well undesired, additional disturbances from being introduced into the (measured substance-)flow by the flow conditioner itself; this, especially, also, in order reliably to provide by means of the flow conditioner a flow profile particularly well suited for exact volume flow- and/or mass flow measurements by means of a ultrasonic-flowmeter, vortex-flowmeter or thermal flowmeter installed downstream from the flow conditioner, also in the case of a (measured substance-)flow having a high Reynolds number, namely a flow profile corresponding to a fully developed turbulent fluid flow, namely a fluid flow of the fluid with isotropic, or at least uniform, turbulence. The invention is based on, among other things, the surprising discovery that disturbances inserted by the flow conditioner into the (measured substance-)flow in the case of high Reynolds numbers can be attributed to, among other things, that boundary layer separations are to be observed in wall neighboring regions of the (measured substance-)flow formed within the diffusor, which can no longer be canceled in sufficient measure by the flow rectifier following the diffusor; this especially for the case, in which a (total-)flare angle of the wall of the diffusor, measured as a greatest (section)angle between two opposite surface elements of the inner surface of the wall, amounts to greater than 16°, frequently also already for the case, in which the (total)flare angle is greater than 12°.

The invention as well as advantageous embodiments thereof will now be explained in greater detail based on examples of embodiments shown in the figures of the drawing. Equal, or equally acting or equally functioning, parts are provided in all figures with equal reference characters; when perspicuity requires or it otherwise appears sensible, reference characters already shown in earlier figures are omitted in subsequent figures. Other advantageous embodiments or further developments, especially also combinations of, firstly, only individually explained aspects of the invention, result, furthermore, from the figures of the drawing and/or from the claims per se.

The figures of the drawing show as follows:

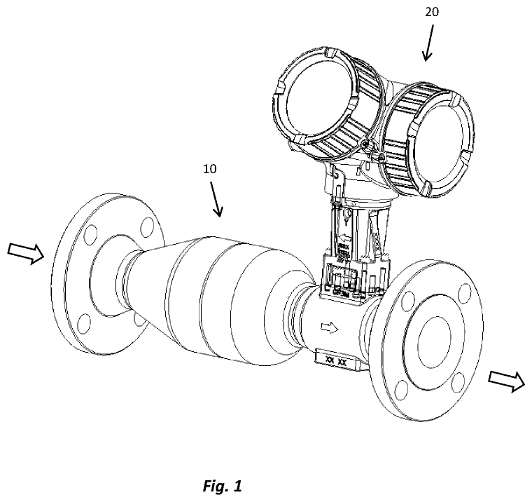

FIG. 1 a perspective side view of a flow conditioner of the invention as well as a measuring system formed therewith;

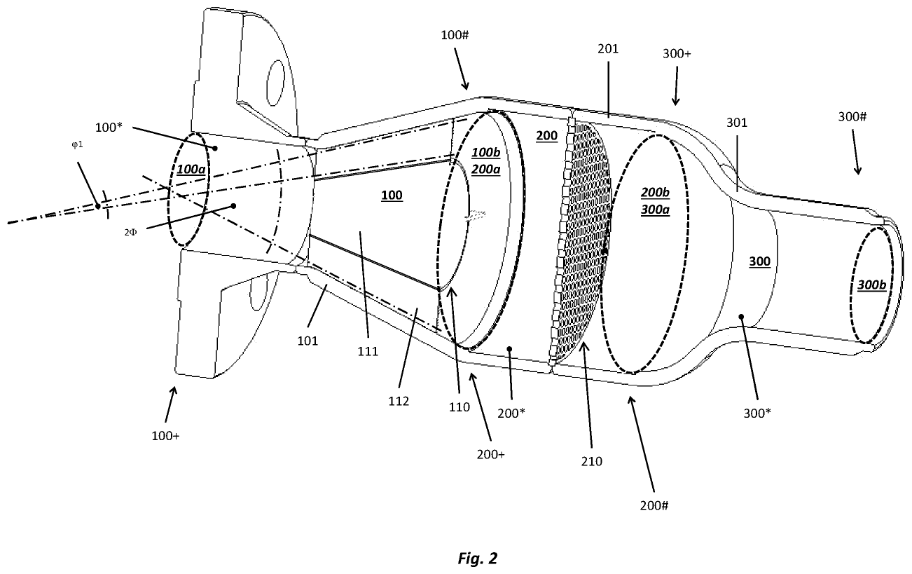

FIG. 2 partiality sectioned, perspective side view of the flow conditioner of the invention shown in FIG. 1;

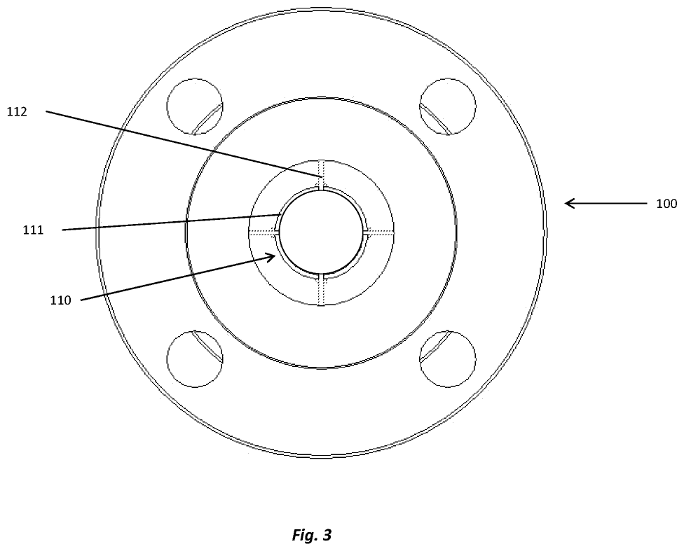

FIG. 3 an axial view of a flow conditioner of FIG. 1;

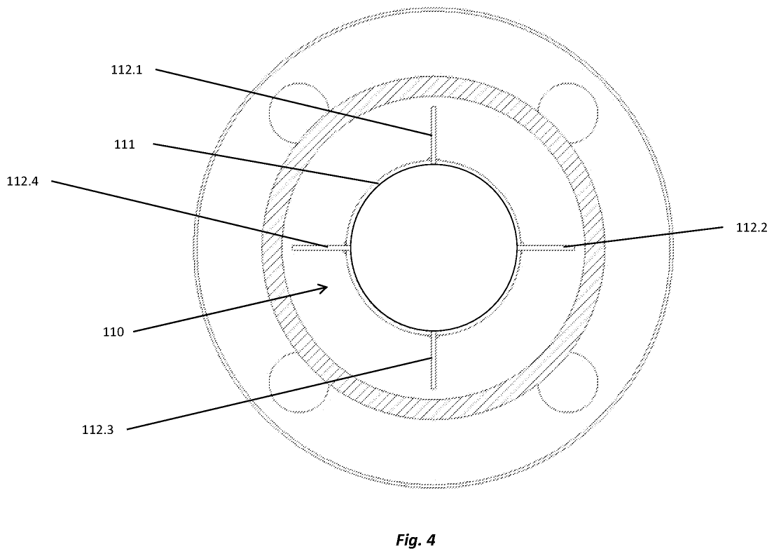

FIG. 4 a FIG. 3 opposed, sectioned, detail view of the flow conditioner of FIG. 1;

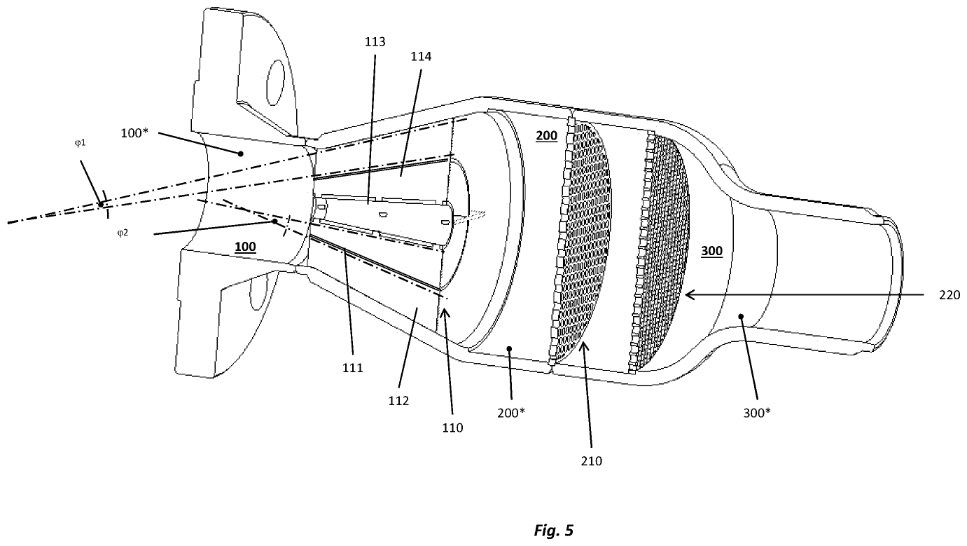

FIG. 5 partiality sectioned, perspective, side view of a variant of a flow conditioner of the invention;

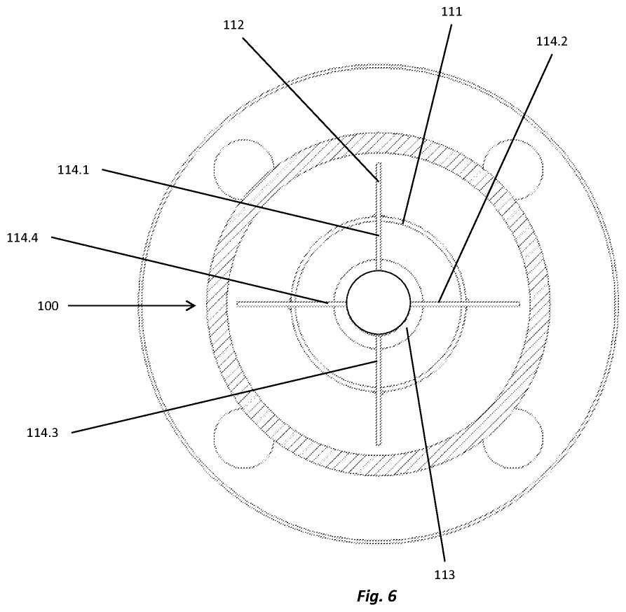

FIG. 6 an axial view of a flow conditioner of FIG. 5;

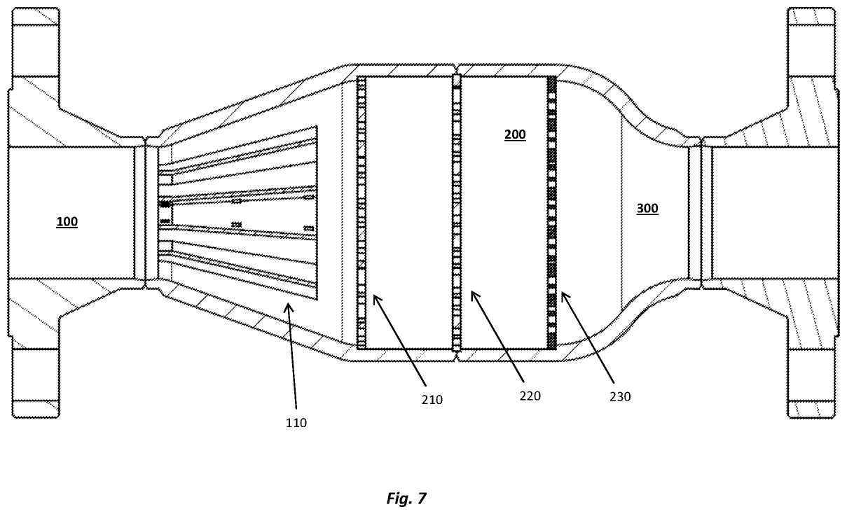

FIG. 7 a sectioned detail side view of the flow conditioner of FIG. 5; and

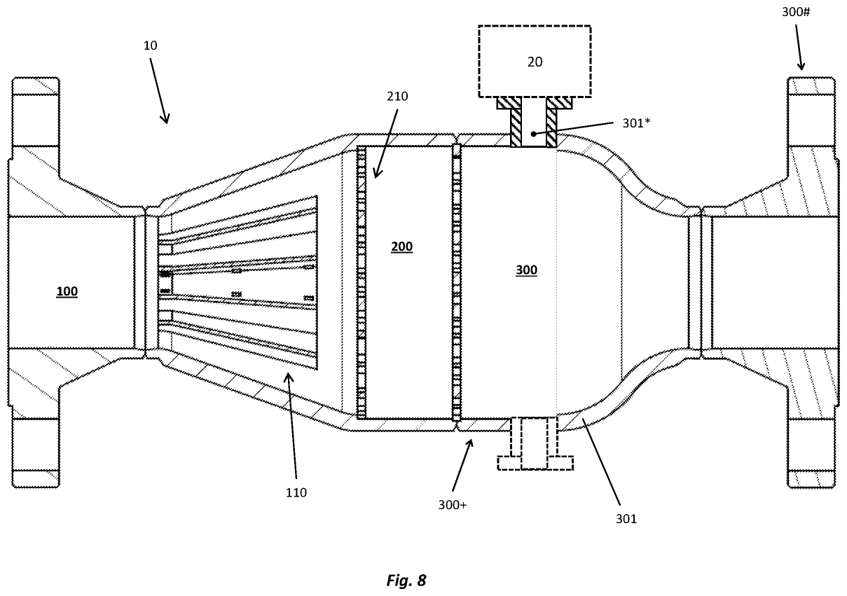

FIG. 8 a sectioned detail side view of another variant of the flow conditioner of the invention.

Shown schematically in FIGS. 1, 2, 3 and 4 in different views is an example of an embodiment of a flow conditioner 10 of the invention. The flow conditioner serves, among other things, to produce in a fluid, for example, a gas, a liquid or a dispersion, flowing with a flow direction in a pipeline, for example, one having a nominal diameter of greater than 15 mm, a fluid flow with uniform or isotropic turbulence; this particularly also in the case of Reynolds-numbers of greater than 1000. In an embodiment of the invention, a nominal diameter of the flow conditioner amounts to greater than 15 mm, for example, not less than 50 mm. The flow conditioner can, additionally, also be adapted to be inserted into the course of the above described pipeline releasably and/or by means of flange connections.

As also shown in FIGS. 1 and 2, also a measuring system can be formed by means of a flow conditioner of the invention to serve for measuring at least one measured variable of a fluid measured substance, for example, a gas, a liquid or a dispersion, flowing with a flow direction, for example, in a pipeline, for example, also in such a manner that the flow conditioner, as well as also indicated in FIGS. 1 and 2, is an integral component of the measuring system.

Flow conditioner 10 of the invention comprises an (in the flow direction, inlet side) diffusor 100, an (in the flow direction, outlet side) confusor 300 as well as a flow rectifier 200 located between diffusor and confusor. Diffusor 100 has a lumen 100* surrounded by a funnel shaped, for example, at least sectionally frustoconically shaped, wall 101, and extending from a first flow opening 100a located in a first diffusor-end 100+, for example, one framed by a connecting flange, to a second flow opening 100b located in a second diffusor-end 100#. Confusor 300 has a lumen 300* surrounded by a funnel shaped, for example, at least sectionally bell shaped and/or at least sectionally trumpet shaped, wall 301, and extending from a first flow opening 300a located in a first confusor-end 300+ to a second flow opening 300b located in a second confusor-end 300#, for example, one framed by a connecting flange. Diffusor 100 can be formed, for example, as a ring-diffusor or as a cone diffusor. Flow rectifier 200 has, in turn, a lumen 200* surrounded by an, for example, at least sectionally cylindrical, wall 201, and extending from a first flow opening 200a located in a first flow rectifier-end 200+ to a second flow opening 200b located in a second flow rectifier end 200# as well as at least one disc shaped (first) flow obstruction 210 arranged within the lumen and having a plurality of, for example, circularly shaped and/or polygonal, flow openings. The at least one flow obstruction 210 of the flow rectifier 200 can be, for example, a turbulence mesh, a sieve or a perforated plate. The flow conditioner can, advantageously, be made, at least partially, by an additive production method, for example, a free space and/or a powder bed method.

In order to be able significantly to lessen a flow velocity of the fluid flowing within the flow rectifier compared with its flow velocity upon entry into the flow conditioner 10, an additional embodiment of the invention provides that a first flow cross section of the diffusor 100 provided by the flow opening 100a of the diffusor 100 is, additionally, sufficiently less than the second flow cross section of the diffusor 100 provided by the flow opening 100b of the diffusor 100 such that the second flow cross section of the diffusor 100 amounts to greater than 1.4-times the first flow cross section of the diffusor, for example, not less than 2 times the first flow cross section of the diffusor 100 and/or no more than 25 times the first flow cross section of the diffusor 100, and/or a first flow cross section of the confusor 300 provided by the flow opening 300a of the confusor 300 is so much more than a second flow cross section of the confusor 300 provided by the flow opening 300b of the confusor 300 that the first flow cross section of the confusor 300 amounts to greater than 1.4-times the second flow cross section of the confusor 300, for example, is not less than 2 times the second flow cross section of the confusor 300 and/or no more than 5 times the second flow cross section of the confusor 300. Alternatively or supplementally, the above-mentioned first flow cross section of the diffusor 100 and the above-mentioned second flow cross section of the confusor 300 can, additionally, be the same size. A hydraulic diameter of the first flow opening of the diffusor, in the case of a circularly shaped first flow cross section of the diffusor 100 corresponding also to the nominal diameter of the flow conditioner, can, such as already indicated, amount to greater than 10 mm, especially also greater than 50 mm.

The wall of the diffusor 100 and/or of the flow rectifier 200 and/or of the confusor 300 can—, as well as also evident from FIGS. 1, 2, 3 and 4, in each case, be formed rotationally symmetrically with respect to an (imaginary) longitudinal-, or rotation axis and/or, in each case, be manufactured of metal. Alternatively or supplementally, the walls of diffusor 100, flow rectifier 200 and confusor 300 can also be made of the same material. In an additional embodiment of the invention, the diffusor and/or the flow rectifier and/or the confusor are/is, furthermore, so formed that their lumina are formed rotationally symmetrically with respect to their at least fourfold (imaginary) rotation axes, and/or that the lumen 100* of the diffusor is formed, at least sectionally, frustoconically shaped and/or the lumen of the flow rectifier is at least sectionally circularly cylindrical and/or the lumen 300* of the confusor is at least sectionally bell shaped and/or at least sectionally trumpet shaped.

As shown in FIGS. 1 and 2, diffusor 100, flow rectifier 200 and confusor 300 are connected fluidically in series to form a flow path of the flow conditioner extending from the flow opening 100a of the diffusor 100 to the flow opening 300b of the confusor 300, namely a flow path involving the lumen 100* of diffusor 100, flow rectifier and confusor, this, for example, in that the diffusor-end 100# is (directly) connected with the flow rectifier-end 200+ and the flow rectifier end 200# with the confusor-end 300+ and/or in such a manner that a transitional region angle xx between the wall 101 of the diffusor 100 and the wall 201 of the flow rectifier 200, measured as a (section-)angle between a surface element of the inner surface of the wall 101 facing the lumen 100* and a therewith aligning surface element of the inner surface of the wall 201 facing the lumen 200* amounts to less than 170° and greater than 45°. Accordingly, in an additional embodiment of the invention, a first flow cross section of the flow rectifier provided by the flow opening 200a of the flow rectifier 200 is the same size as the second flow cross section 100b of the diffusor 100. Furthermore, a second flow cross section of the flow rectifier 200 provided by the flow opening 200b of the flow rectifier 200 is the same size as the first flow cross section of the confusor 300. Alternatively or supplementally, additionally, also the above-mentioned second flow cross section of the flow rectifier can be the same size as the first flow cross section of the flow rectifier, and, accordingly, the second flow cross section of the diffusor 100 and the first flow cross section of the confusor can be the same size.

In an additional embodiment of the invention, diffusor 100, flow rectifier 200 and confusor 300 are embodied and arranged in such a manner that an imaginary longitudinal-, or flow, axis of the flow conditioner imaginarily connecting an (area-)center of gravity of the flow opening 100a of the diffusor 100 and an (area-)center of gravity of the flow opening 300b of the confusor 300 coincides with a principal axis of inertia of the lumen of the diffusor 100, for example, one corresponding to an at least fourfold (imaginary) rotation axis, and/or with a principal axis of inertia of the lumen of the confusor 300, for example, one corresponding to an at least fourfold (imaginary) rotation axis, and/or with an (imaginary) longitudinal-, or flow, axis of the lumen of the flow rectifier 200 imaginarily connecting an (area-)center of gravity of the flow opening 200a of the flow rectifier 200 and an (area-)center of gravity of the flow opening 200b of the flow rectifier 200.

The at least one flow obstruction 210 of the flow rectifier 200 is, in an additional embodiment of the invention, furthermore, so formed, especially namely number and size of its flow openings are so selected, that a first reduced flow cross section of the flow rectifier provided by the flow openings of the first flow obstruction of the flow rectifier is, in total, not less than 0.3-times the above described, first flow cross section of the flow rectifier. Alternatively thereto or in supplementation thereof, a flow cross section of a largest flow opening of the first flow obstruction is so selected that it amounts to not less than 0.1-times and/or no more than 0.3 times the above described, first flow cross section of the diffusor 100. In an additional embodiment of the invention, the at least one flow obstruction 210 of the flow rectifier has flow openings with flow cross sections differing from one another; this, for example, in such a manner that a flow cross section of a largest flow opening of the flow obstruction 210 amounts to not less than 1.1-times and/or no more than a 1.5 times a smallest flow opening of the flow obstruction 210. For additionally improving the effectiveness of the flow rectifier 200, such has in an additional embodiment of the invention at least a second disc shaped flow obstruction 220 constructed differently from flow obstruction 210, having a plurality of flow openings, and arranged in the direction of an (imaginary) longitudinal axis of the flow rectifier spaced from the flow obstruction 210 within the lumen of the flow rectifier 200; this especially in such a manner that the flow obstructions 210, 220 are oriented in parallel relative to one another and/or that the flow obstruction 220 is positioned in the flow direction downstream from the flow obstruction 210, and closer to the flow opening 200b than the flow obstruction 210. The flow obstructions 210, 220 can, furthermore, be so formed that a first reduced flow cross section of the flow rectifier 200 provided, in total, by the flow openings of the flow obstruction 210 is not greater than a second reduced flow cross section of the flow rectifier provided, in total, by the flow openings of the above described flow obstruction 220, and that a flow cross section of a largest flow opening of the flow obstruction 210 is not less than a flow cross section of a largest flow opening of the flow obstruction 220. Alternatively or supplementally, the flow obstructions 210, 220 can advantageously also be so arranged that they are spaced from one another in the direction of the above described (imaginary) longitudinal axis of the flow rectifier by not less than 5-times a square root of a flow cross section of a largest flow opening of the flow obstruction 210 and/or not less than 5-times a hydraulic diameter of a largest flow opening of the flow obstruction 210. In case required, the flow rectifier 200 can, furthermore, also have at least a disc shaped third flow obstruction 230 having a plurality of flow openings, for example, one constructed differently from the flow obstruction 210 and/or the flow obstruction 220, for example, spaced in the direction of the longitudinal axis of the flow rectifier from the flow obstruction 220, namely arranged in the flow direction downstream from the flow obstruction 220 within the lumen of the flow rectifier 200.

In the case of the flow conditioner of the invention, the diffusor 100 comprises, furthermore, a guide system 110 arranged within its lumen 100* and serving particularly for preventing a (turbulent) boundary layer separation. The guide system 110 of the diffusor has, such as evident from a combination of FIGS. 2, 3 and 4, at least one sleeve shaped, for example, at least sectionally hollow cylinder shaped and/or at least sectionally funnel shaped, first deflection means 111 as well as a plurality of mutually separated connecting elements 112 (112.1, 112.2, 112.3, 112.4), in each case, connected both with the deflection means 111 as well as also with the wall of the diffusor, for example, connecting elements constructed equally to one another. In an additional embodiment of the invention, at least the guide system 110 is an, especially additively produced, monolithic, formed part, for example, in such a manner that at least the deflection means 111 and the connecting elements 112 parts are one and the same monolithic, formed part. In an additional embodiment of the invention, it is, additionally, provided that both the deflection means 111, the connecting elements 112 as well as the wall 101 of the diffusor 100 are one and the same, monolithic, formed part.

According to the invention, the guide system 110 is, additionally, so formed and so positioned that the deflection means 111 is arranged spaced from the wall 101 of the diffusor 100 and coaxially with the lumen of the diffusor, for example, in such a manner that, such as directly evident from a combination of FIGS. 2, 3 and 4, a principal axis of inertia of the deflection means 111 coincides with a principal axis of inertia of the lumen 200* of the diffusor 200; this, especially, in such a manner that one or more subsections of the above described flow path of the flow conditioner extend through the deflection means 111 and/or that one or more subsections of the flow path of the flow conditioner 10 extend between the deflection means 111 and the wall 201 of the diffusor 200, for example, a subsection of the flow path of the flow conditioner extends, in each case, between two neighboring connecting elements 112 connected, in each case, with the deflection means 111 and with the wall of the diffusor. The deflection means 111 of the guide system 110 is, in an additional embodiment of the invention, rotationally symmetric with respect to an at least fourfold (imaginary) rotation axis (longitudinal axis). Furthermore, the connecting elements 111 of the guide system can be formed, for example, rod shaped and/or plate shaped. Additionally, the connecting elements 112 can be arranged star shaped along a lateral surface of the deflection means 111 facing the wall 120 of the diffusor 100 and/or equidistantly along a (circularly shaped) circumferential line of the lateral surface of the deflection means 111. Alternatively or supplementally, deflection means 111 and connecting elements 112 can, additionally, for example, be made of the same material and/or of metal. In an additional embodiment of the invention, the at least one deflection means 111 of the guide system 110 is, furthermore, so formed and arranged that an axis formed by its principal axis of inertia, for example, a principal axis of inertia corresponding to an at least fourfold rotation axis of the deflection means, coincides with a principal axis of inertia of the lumen 100* of the diffusor 100 corresponding, for example, to an at least fourfold rotation axis of the lumen of the diffusor. Furthermore, the guide system 110 can, additionally, be so formed that it is rotationally symmetric with respect to an at least threefold rotation axis corresponding, for example, also to an (imaginary) longitudinal axis of the guide system, or of the diffusor. Additionally, the guide system 110 can be so positioned within the lumen of the diffusor that the above-mentioned at least threefold (imaginary) rotation axis, or longitudinal axis of the guide system, coincides with a principal axis of inertia of the lumen 100* of the diffusor 100.

For lessening the risk of occurrence of undesired boundary layer separations within the diffusor, or within the flow conditioner formed therewith, in an additional embodiment of the invention, the guide system 110 and the wall 101 are, furthermore, so embodied that a (first) critical flare angle φ1 of the diffusor 100, measured as a greatest (section-)angle between a (wall 101 facing) lateral surface element of the deflection means 111 and an opposite, or nearest, surface element of the (lumen 100* facing) inner surface of the wall 101 of the diffusor 100, amounts to (FIG. 2) less than 8°, especially no greater than 6°, and is less than a flare angle, above which an onset of boundary layer separations in the wall vicinity of the fluid flow is to be expected. By application of the guide system 110, it is thus, among other things, enabled, as a whole, to enlarge a corresponding (total-)flare angle 2Φ of the wall 101 of the diffusor 100, measured as a greatest (section-)angle between two opposite surface elements of the inner surface of the wall 101 from a—typically about 16°-12° or less amounting—flare angle of the diffusor in conventional flow rectifiers of the type being discussed, for example, to more than 16°, or twice that, without risk of boundary layer separations in the wall vicinity of the fluid flow, and, associated therewith, also in corresponding measures to shorten an installed length of the flow conditioner, measured as a (smallest) separation between the diffusor end 100+ and the confusor end 300# compared with installed length of conventional flow conditioners of the type being discussed, coupled with equal efficiency, or effectiveness, with reference to forming a fully developed turbulent flow profile output of the flow conditioner. Accordingly, in an additional embodiment of the invention, the flow conditioner is so formed that its installed length amounts to no more than 15-times, especially less than 12 times, a square root of the above described, first flow cross section of the diffusor 100, and no more than 12 times, especially less than 10 times, a hydraulic diameter of the flow opening 100a of the diffusor 100, or a nominal diameter of the flow rectifier, for example, also in the manner that the installed length amounts to no more than 5 times the hydraulic diameter of the flow opening 100a of the diffusor, or the nominal diameter of the flow rectifier. For such purpose, in an additional embodiment of the invention, the diffusor is so formed that a length of the diffusor, measured as a (smallest) separation between the diffusor end 100+ and the diffusor end 100#, amounts to no more than 0.4 times the installed length of the flow conditioner and/or no more than 7 times the square root of the first flow cross section of the diffusor 100, or no more than 6 times the hydraulic diameter of the first flow opening of the diffusor 100; this especially also in the manner that the above-mentioned length of the diffusor 100 is not less than 0.2-times the installed length of the flow conditioner.

For additionally improving the above described efficiency of the flow conditioner as regards the forming of a fully developed turbulent flow profile in the case of established installed length, the guide system 110 includes, in an additional embodiment of the invention—, as well as also indicated in FIGS. 5 and 6 and directly evident from their combination—, furthermore, a sleeve shaped, second deflection means 113 for example, one at least sectionally hollow cylinder shaped and/or—such as shown in FIG. 5—at least sectionally funnel shaped, as well as a plurality of mutually separated connecting elements 114 (114.1, 114.2, 114.3, 114.4), for example, rod shaped and/or plate shaped connecting elements, connected, in each case, both with the second deflection means 113 as well as also the first deflection means 111 and the guide system 110 is, additionally, so formed and positioned that the deflection means 113 is arranged spaced from both the wall 120 of the diffusor 100 as well as also from the deflection means 111 and coaxially with the lumen of the diffusor 100, for example, also within the deflection means 111; this, especially, also in such a manner that a principal axis of inertia of the deflection means 113 coincides with the above described principal axis of inertia of the lumen of the diffusor 200, and with the above described principal axis of inertia of the deflection means 111 and/or that one or more subsections of the above described flow path of the flow conditioner extends through the deflection means 113 and/or that one or more subsections of the flow path of the flow conditioner extends between the deflection means 113 and the deflection means 111, for example, in each case, a subsection of the flow path of the flow conditioner extends between two neighboring connecting elements 114 connected, in each case, with the deflection means 113 and the deflection means 111. The deflection means 113 and the connecting elements 114 can be made, for example, of the same material, for example, also of the same material as the deflection means 111, and the connecting elements 112, and/or of metal. Additionally, the connecting elements 114 can be of equal construction and/or be arranged star shaped along a lateral surface of the deflection means 113 facing the deflection means 111, or equidistantly along a circumferential line of the lateral surface of the deflection means 113. In an additional embodiment of the invention, the deflection means 113 of the guide system 110 is rotationally symmetric with respect to an at least fourfold (imaginary) rotation axis (longitudinal axis), for example, also in such a manner that each of the deflection means 111, 113 of the guide system 110 is, in each case, formed rotationally symmetrically with respect to an at least fourfold (imaginary) rotation axis (longitudinal axis) and, additionally, are so arranged that the axes of rotation are coincident and/or that a (second) critical flare angle φ2 of the diffusor 100, measured as a greatest (section-)angle between a (deflection means 111 facing) surface element of the deflection means 112 and an opposite, or nearest, surface element of (the deflection means 112 facing) inner surface of the deflection means 111 amounts to (FIG. 5) less than 8°, especially no greater than 6°; this, especially, also in such a manner that both the above-mentioned critical flare angle φ1 as well as also the critical flare angle φ2, in each case, amounts to less than 8°, especially, in each case, no more than 6°, and/or that the above-mentioned (total-)flare angle 2Φ the wall 101 of the diffusor 100 amounts to greater than 20°, for example, greater than 30 .

The guide system 110 can, furthermore, also be provided and adapted to remove or at least in sufficient measure reduce swirl possibly formed in the fluid flowing into the flow conditioner, for example, by means of guide areas, or guide vanes, applied on the deflection means 111 and/or on the wall 120 of the diffusor 100. For such purpose, advantageously also some or all of the connecting elements 112 of the guide system, in given cases, also some or all the connecting elements 114, can, in each case, be formed as guide vanes and, additionally, be so arranged that by means of the connecting elements 112, respectively 114 a vane ring the guide system 110 is formed, especially, one serving for removing swirl from a fluid flowing through the diffusor 100. Accordingly, in an additional embodiment of the invention, at least three, for example, also four or more, connecting elements 112 are, in each case, formed as guide vanes having, especially, flat and/or symmetrical profiles. Alternatively or supplementally, accordingly also the, in given cases, provided connecting elements 114 can, in each case, be formed as guide vanes having, especially, flat and/or symmetrical profiles.

As already indicated, the flow conditioner, especially, can also be formed as a component of a measuring system serving for measuring one or more measured variables, for example, at least one flow parameter and/or at least one substance parameter, of a flowing, fluid, measured substance. Such a measuring system can, accordingly, comprise, besides the flow conditioner 10 of the invention, at least one measuring device 20, for example, a flowmeter, such as, for instance, a vortex-flowmeter, a thermal (mass flow)meter, an ultrasonic flowmeter or an (in-line)flowmeter measuring other flow parameters, a temperature measuring device, a pressure measuring device and/or an (ultra)sonic measuring device measuring ultrasound propagated by the flowing, measured substance and/or emitted sound. The (in-line)flowmeter of the measuring system can—, as well as also shown in FIG. 1—advantageously be arranged downstream from the flow conditioner, for example, connected directly to the confusor 300, in such a manner that the flow conditioner and the flowmeter are connected fluidically in series to form a flow path extending from the flow opening 100a of the diffusor 100 to an outlet opening of the flowmeter located in a flowmeter-outlet end remote from the confusor-end 300b of the confusor 300, namely a flow path involving the lumina of diffusor 100, flow rectifier 200 and confusor 300 as well as also a lumen of the flowmeter extending from an inlet opening of the flowmeter located in a measuring device-inlet end to its outlet opening, for example, in that the flowmeter-inlet end is connected with the confusor-end 300# of the confusor 300. Alternatively or supplementally, at least the above-mentioned temperature-measuring device and/or the above-mentioned pressure measuring device and/or the above-mentioned (ultra)sonic flowmeter—such as shown schematically in FIG. 8—can, in each case, also be arranged directly on the, or partially within the, flow conditioner 10, especially on the wall of the confusor 300; this, for example, in such a manner that the temperature-measuring device includes at least one temperature sensor positioned within the lumen of the confusor 300, or that the pressure-measuring device includes a pressure sensor contacting the lumen via an opening in the wall of the confusor 300, or that the (ultra-)sonic-flowmeter has a microphone contacting the wall of the diffusor on a lumen far, outside of the wall and/or two mutually oppositely lying ultrasonic transceivers, in each case, contacting the wall of the diffusor on a lumen far, outside of the wall. Each of the above described temperature, pressure measuring device, or (ultra)sonic measuring devices can, additionally, be electrically connected with a flowmeter arranged, in given cases, downstream from the flow conditioner, for example, in order to receive measurement data from the flowmeter and/or to transmit measurement data to the flowmeter. For (fluidic) connecting of the above described pressure-measuring device or the above described temperature measuring device, there can be provided in the wall of the confusor 301, furthermore, at least one wall opening 301*, for example, firstly, closed with a plug and/or equipped with a corresponding connection nozzle. Advantageously, the wall opening can be located in the direction of gravity at a lowest or highest point of the diffusor. Alternatively or supplementally, the above-mentioned wall opening can also be used to connect a condensate drain or a gas separator fluidically to the flow conditioner.

1-29. (canceled)

30. A flow conditioner for a fluid flowing in a pipeline, comprising:
a diffusor,
having a lumen surrounded by a funnel shaped wall extending from a first flow opening to a second flow opening located in a second diffusor-end, and having a guide system arranged within the lumen;
a flow rectifier,
having a lumen surrounded by a wall and extending from a first flow opening located in a first flow rectifier-end to a second flow opening located in a second flow rectifier end, and having at least one disc shaped (first) flow obstruction; and
a confusor having a lumen surrounded by a funnel shaped wall and extending from a first flow opening located in a first confusor-end to a second flow opening located in a second confusor-end;
wherein diffusor, flow rectifier and confusor are connected fluidically in series to form a flow path extending from the first flow opening of the diffusor to the second flow opening of the confusor, namely a flow path involving the lumina of diffusor, flow rectifier and confusor;
wherein the guide system has
at least one sleeve shaped first deflection means, as well as
a plurality of mutually separated connecting elements each connected both with the first deflection means as well as also with the wall of the diffusor; and
wherein the guide system is so formed and so positioned that the first deflection means is arranged spaced from the wall of the diffusor and coaxially with the lumen of the diffusor.

31. The flow conditioner as claimed in claim 30,
wherein the guide system is so formed and so positioned that one or more subsections of the flow path of the flow conditioner extend through the first deflection means; and/or
wherein the guide system is so formed and so positioned that one or more subsections of the flow path of the flow conditioner extend between the first deflection means and the wall of the diffusor; and/or
wherein the guide system is so formed and so positioned that, in each case, a subsection of the flow path of the flow conditioner extends between two neighboring connecting elements connected, in each case, with the first deflection means and the wall of the diffusor.

32. The flow conditioner as claimed in claim 30, wherein the guide system and the wall of the diffusor are so embodied that a (first) critical flare angle φ1 of the diffusor, measured as a greatest (section-)angle between a lateral surface element of the deflection means and an opposite, or nearest, surface element of an inner surface of the wall of the diffusor facing the lumen of the diffusor amounts to less than 8°.

33. The flow conditioner as claimed in claim 30,
wherein a principal axis of inertia of the first deflection means, corresponding to an at least fourfold rotation axis of the first deflection means, coincides with a principal axis of inertia of the lumen of the diffusor, corresponding to an at least fourfold rotation axis of the lumen of the diffusor; and/or
wherein the guide system is rotationally symmetric with respect to an at least threefold (imaginary) rotation axis (longitudinal axis); and/or
wherein at least three connecting elements are formed each as a flat and/or symmetrically profiled, guide means; and/or
wherein a vane ring is formed by means of the connecting elements.

34. The flow conditioner as claimed in claim 30,
wherein the guide system has
a sleeve shaped second deflection means, as well as
a plurality of mutually separated connecting elements, in each case, connected both with the second deflection means as well as also with the first deflection means and/or, in each case, embodied as guide means and/or arranged equidistantly along a peripheral line of the lateral surface of the second deflection means; and
wherein the guide system is so formed and so positioned that the second deflection means is arranged spaced from both the wall of the diffusor as well as also from the first deflection means and coaxially with the lumen of the diffusor.

35. The flow conditioner as claimed in claim 34,
wherein the guide system is so formed and so positioned that one or more subsections of the flow path of the flow conditioner extend through the second deflection means; and/or wherein the guide system is so formed and so positioned that one or more subsections of the flow path of the flow conditioner extend between the second deflection means and the first deflection means; and/or
wherein the guide system is so formed and so positioned that a subsection of the flow path of the flow conditioner extends between two neighboring connecting elements connected, in each case, with the first deflection means and the second deflection means; and/or
wherein the guide system of the diffusor is so embodied that a (second) critical flare angle φ2 of the diffusor, measured as a greatest (section-)angle between a lateral surface element of the second deflection means and an opposite, or nearest, surface element of an inner surface of the first deflection means facing the second deflection means amounts to less than 8°.

36. The flow conditioner as claimed in claim 30, wherein a first flow cross section of the confusor provided by the first flow opening of the confusor is greater than a second flow cross section of the confusor provided by the second flow opening of the confusor.

37. The flow conditioner as claimed in claim 36,
wherein the first flow cross section of the confusor is the same size as the second flow cross section of the diffusor; and/or
wherein the first flow cross section of the diffusor is the same size as the second flow cross section of the confusor.

38. The flow conditioner as claimed in claim 30,
wherein a principal axis of inertia (longitudinal axis) of the lumen of the diffusor coincides with an imaginary longitudinal-, or flow, axis of the flow conditioner imaginarily connecting an (area-)center of gravity of the first flow opening of the diffusor and an (area-)center of gravity of the second flow opening of the confusor; and/or
wherein an (imaginary) longitudinal-, or flow, axis of the lumen of the diffusor imaginarily connecting an (area-)center of gravity of the first flow opening of the diffusor and an (area-)center of gravity of the second flow opening of the diffusor coincides with an imaginary longitudinal-, or flow, axis of the flow conditioner imaginarily connecting an (area-)center of gravity of the first flow opening of the diffusor and an (area-)center of gravity of the second flow opening of the confusor; and/or
wherein a principal axis of inertia (longitudinal axis) of the lumen of the confusor coincides with an imaginary longitudinal-, or flow, axis of the flow conditioner imaginarily connecting an (area-)center of gravity of the first flow opening of the diffusor and an (area-)center of gravity of the second flow opening of the confusor; and/or
wherein an (imaginary) longitudinal-, or flow, axis of the lumen of the confusor imaginarily connecting an (area-)center of gravity of the first flow opening of the confusor and an (area-)center of gravity of the second flow opening of the confusor coincides with an imaginary longitudinal-, or flow, axis of the flow conditioner imaginarily connecting an (area-)center of gravity of the first flow opening of the diffusor and an (area-)center of gravity of the second flow opening of the confusor; and/or
wherein an (imaginary) longitudinal-, or flow, axis of the lumen of the flow rectifier imaginarily connecting an (area-)center of gravity of the first flow opening of the flow rectifier and an (area-)center of gravity of the second flow opening of the flow rectifier coincides with an imaginary longitudinal-, or flow, axis of the flow conditioner imaginarily connecting an (area-)center of gravity of the first flow opening of the diffusor and an (area-)center of gravity of the second flow opening of the confusor.

39. The flow conditioner as claimed in claim 30, wherein a first flow cross section of the diffusor provided by the first flow opening of the diffusor is less than a second flow cross section of the diffusor provided by the second flow opening of the diffusor.

40. The flow conditioner as claimed in claim 39,
wherein the second flow cross section of the diffusor amounts to greater than 1.4-times the first flow cross section of the diffusor; and/or
wherein a flow cross section of a largest flow opening of the first flow obstruction amounts to not less than 0.1-times the first flow cross section of the diffusor and/or no more than 0.3 times the first flow cross section of the diffusor.

41. The flow conditioner as claimed in claim 40, wherein an installed length of the flow conditioner, measured as a (smallest) separation between the first diffusor-end and the second confusor end, amounts to no more than 15 times a square root of the first flow cross section of the diffusor and/or no more than 12 times a hydraulic diameter of the first flow opening of the diffusor and/or a nominal diameter of the flow rectifier amounts to no more than one 5 times the hydraulic diameter of the first flow opening of the diffusor, or the nominal diameter of the flow rectifier.

42. The flow conditioner as claimed in claim 41,
wherein a length of the diffusor amounts to not less than 0.2-times and/or no more than 0.4 times the installed length of the flow conditioner; and/or
wherein a length of the diffusor amounts to no more than 7-times the square root of the first flow cross section of the diffusor and/or no more than 6 times the hydraulic diameter of the first flow opening of the diffusor and/or the nominal diameter of the flow rectifier.

43. The flow conditioner as claimed in claim 30,
wherein a nominal diameter of the flow conditioner amounts to greater than 15 mm; and/or wherein a hydraulic diameter of the first flow opening of the diffusor amounts to greater than 15 mm.

44. The flow conditioner as claimed in claim 39, wherein a first flow cross section of the flow rectifier provided by the first flow opening of the flow rectifier is the same size as the second flow cross section of the diffusor.

45. The flow conditioner as claimed in claim 44,
wherein a second flow cross section of the flow rectifier provided by the second flow opening of the flow rectifier is the same size as the first flow cross section of the flow rectifier and/or the first flow cross section of the confusor; and/or
wherein a first reduced flow cross section of the flow rectifier provided, in total, by the flow openings of the first flow obstruction of the flow rectifier is not less than 0.3-times the first flow cross section of the flow rectifier.

46. The flow conditioner as claimed in claim 30, wherein the at least one flow obstruction has flow openings with flow cross sections differing from one another.

47. The flow conditioner as claimed in claim 30, wherein the flow rectifier has at least a second flow obstruction, which is disc shaped and has a plurality of flow openings.

48. The flow conditioner as claimed in claim 47,
wherein a first reduced flow cross section of the flow rectifier provided, in total, by the flow openings of the first flow obstruction of the flow rectifier is not greater than a second reduced flow cross section of the flow rectifier provided, in total, by the flow openings of the second flow obstruction of the flow rectifier; and/or
wherein a flow cross section (hydraulic diameter) of a largest flow opening of the first flow obstruction is not less than a flow cross section of a largest flow opening of the second flow obstruction; and/or wherein the first and second flow obstructions of the flow rectifier are spaced from one another in the direction of an (imaginary) longitudinal axis of the flow rectifier.

49. The flow conditioner as claimed in claim 48, wherein the flow rectifier has at least a third flow obstruction, which is disc shaped and has a plurality of flow openings, especially a third flow obstruction having a construction different from the first flow obstruction and/or the second flow obstruction.

50. The flow conditioner as claimed in claim 30, which flow conditioner is adapted to be inserted into the course of a pipeline.

51. The flow conditioner as claimed in claim 30,
wherein the wall of the diffusor has at least one wall-opening, for connecting a condensate outlet, a gas separator, a pressure measuring device or a temperature measuring device; and/or
wherein the wall of the confusor has at least one wall-opening, for connecting a condensate outlet, a gas separator, a pressure measuring device or a temperature measuring device.

52. The flow conditioner as claimed in claim 30, wherein the wall of the confusor has at least two wall-openings for connecting both a pressure measuring device as well as also a temperature measuring device to the flow conditioner or for connecting an ultrasonic measuring device to the flow conditioner.

53. The flow conditioner as claimed in claim 30, produced, at least partially, by an additive production method, especially a free space and/or a powder bed method.

54. The flow conditioner as claimed in claim 30,
wherein at least the guide system of the diffusor is a monolithic, formed part; and/or
wherein the deflection means and the connecting elements of the guide system are components of one and the same monolithic, formed part.

55. A measuring system for measuring at least one measured variable of a fluid flowing with a flow direction, wherein the measuring system comprises a flow conditioner, wherein the flow conditioner includes:
a diffusor,
having a lumen surrounded by a funnel shaped wall extending from a first flow opening to a second flow opening located in a second diffusor-end, and
having a guide system arranged within the lumen;
a flow rectifier,
having a lumen surrounded by a wall and extending from a first flow opening located in a first flow rectifier-end to a second flow opening located in a second flow rectifier end, and having at least one disc shaped (first) flow obstruction; and
a confusor having a lumen surrounded by a funnel shaped wall and extending from a first flow opening located in a first confusor-end to a second flow opening located in a second confusor-end;
wherein diffusor, flow rectifier and confusor are connected fluidically in series to form a flow path extending from the first flow opening of the diffusor to the second flow opening of the confusor, namely a flow path involving the lumina of diffusor, flow rectifier and confusor;
wherein the guide system has
at least one sleeve shaped first deflection means, as well as
a plurality of mutually separated connecting elements each connected both with the first deflection means as well as also with the wall of the diffusor; and
wherein the guide system is so formed and so positioned that the first deflection means is arranged spaced from the wall of the diffusor and coaxially with the lumen of the diffusor.

56. The measuring system of claim 55, further comprising a flowmeter arranged downstream from the flow conditioner.

57. The measuring system as claimed in claim 56, wherein the flow conditioner and the flowmeter are connected fluidically in series to form a flow path extending from the first flow opening of the diffusor to an outlet opening of the flowmeter located in a flowmeter-outlet end remote from the second confusor-end, namely a flow path involving both the lumina of diffusor, flow rectifier and confusor as well as also a lumen of the flowmeter extending from an inlet opening of the flowmeter located in a flowmeter-inlet end to its outlet opening, especially in that the flowmeter inlet end is connected with the second confusor-end.

58. The measuring system as claimed in claim 55, further comprising
a temperature-measuring device arranged at the wall of the confusor of the flow conditioner,
a pressure-measuring device arranged at the wall of the confusor of the flow conditioner, and/or
an (ultra-)sonic-measuring device arranged on the wall of the confusor of the flow conditioner, and/or
in the wall of the confusor at least one wall-opening.
